(19) United States
(12) Patent Application Publication
(10) Pub. No.: US 2011/0010870 A1
(43) Pub. Date: Jan. 20, 2011

(54) Method of Laundering Fabric Using a Compacted Laundry Detergent Composition

(75) Inventors: Alan Thomas Brooker, Newcastle upon Tyne (GB); Nigel Patrick Somerville Roberts, Newcastle upon Tyne (GB); Gregory Scol Miracle, Hamilton, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(73) Assignee: The Procter & Gamble Company, Cincinnati, OH (US)

(21) Appl. No.: 12/888,629

(22) Filed: Sep. 23, 2010

Related U.S. Application Data
(63) Continuation of application No. PCT/US2010/041138, filed on Jul. 7, 2010.
(60) Provisional application No. 61/325,401, filed on Apr. 19, 2010.
(60) Provisional application No. 61/224,151, filed on Jul. 9, 2009.

(51) Int. Cl. C11D 3/39; C11D 17/00; D06L 1/20; C11D 17/08

(52) U.S. Cl. 8/137; 510/337; 510/339; 510/309

(57) ABSTRACT

A method of laundering fabric having the step of contacting a solid laundry detergent composition having bleach to water to form a wash liquor, and laundering fabric in the wash liquor, wherein the composition has a reserve alkalinity of 5.0 or greater, wherein the laundry detergent is contacted to water in such an amount so that the concentration of laundry detergent composition in the wash liquor is from above 0 g/l to 5 g/l, and wherein from 0.01 kg to 2 kg of fabric per litre of wash liquor is dosed into said wash liquor.

### CROSS REFERENCE TO RELATED APPLICATION(S)

This application is a Continuation of International Application No. PCT/US2010/041138, filed Jul. 7, 2010 which claims the benefit of U.S. Provisional Application No. 61/325,401, filed Apr. 19, 2010 and U.S. Provisional Application No. 61/224,151, filed Jul. 9, 2009.

### FIELD OF THE INVENTION

The present invention relates to a method of laundering fabric. The method exhibits good bleach performance and has an excellent environmental profile.

### BACKGROUND OF THE INVENTION

As one wishes to remove more and more chemistry from solid laundry detergent products, one must optimize the cleaning performance of what is left or suffer a severe reduction in cleaning performance. This is especially true for bleaching performance.

As one removes more and more hydrogen peroxide source, less hydrogen peroxide is available to be converted into a perhydroxy anion, and in turn (in the presence of decreasing levels of bleach activators) less peracid is available to contribute to bleaching performance. In addition to this, as one reduces the dosage of the product into the wash liquor, the pH of the wash liquor is likely to reduce, which in turn reduces the proportion of hydrogen peroxide that exists as a perhydroxy anion.

What remains constant though is the amount of fabric typically laundered during the washing process. So less bleach is used to clean the same amount of fabric. In addition, as well as being the substrate to be cleaned, this fabric brings in its own stress on the bleaching system, namely in the form of catalase, which is present in the fabric to be laundered, and rapidly catalyzses the decomposition of hydrogen peroxide to water and oxygen, thereby reducing the performance of the bleaching system.

The inventors have found that by carefully controlling the reserve alkalinity of the solid laundry detergent composition, one can maintain a good bleaching performance whilst at the same time compact the formulation and the bleach system.

The inventors herein provide a method of laundering fabric having a good bleach performance profile, whilst at the same time having a good environmental profile.

### SUMMARY OF THE INVENTION

The present invention relates to a method of laundering fabric as defined by the claims.

### DETAILED DESCRIPTION OF THE INVENTION

### Method of Laundering Fabric

The method of laundering fabric comprises the step of contacting a solid laundry detergent composition comprising bleach to water to form a wash liquor, and laundering fabric in said wash liquor. The fabric may be contacted to the water prior to, or after, or simultaneous with, contacting the laundry detergent composition with water.

Typically, the wash liquor is formed by contacting the laundry detergent to water in such an amount so that the concentration of laundry detergent composition in the wash liquor is from above 0 g/l to 5 g/l, preferably from 1 g/l, and preferably to 4.5 g/l, or to 4.0 g/l, or to 3.5 g/l, or to 3.0 g/l, or to 2.5 g/l, or even to 2.0 g/l, or even to 1.5 g/l.

Highly preferably, the method of laundering fabric is carried out in a front-loading automatic washing machine. In this embodiment, the wash liquor formed and concentration of laundry detergent composition in the wash liquor is that of the main wash cycle. Any input of water during any optional rinsing step(s) that typically occurs when laundering fabric using a front-loading automatic washing machine is not included when determining the volume of the wash liquor. Of course, any suitable automatic washing machine may be used, although it is extremely highly preferred that a front-loading automatic washing machine is used.

It is highly preferred for the wash liquor to comprise 40 litres or less of water, preferably 35 litres or less, preferably 30 litres or less, preferably 25 litres or less, preferably 20 litres or less, preferably 15 litres or less, preferably 12 litres or less, preferably 10 litres or less, preferably 8 litres or less, or even 6 litres or less of water. Preferably, the wash liquor comprises from above 0 to 15 litres, or from 1 litre, or from 2 litres, or from 3 litres, and preferably to 12 litres, or to 10 litres, or even to 8 litres of water. Most preferably, the wash liquor comprises from 1 litre, or from 2 litres, or from 3 litres, or from 4 litres, or even from 5 litres of water.

Typically from 0.01 kg to 2 kg of fabric per litre of wash liquor is dosed into said wash liquor. Typically from 0.01 kg, or from 0.02 kg, or from 0.03 kg, or from 0.05 kg, or from 0.07 kg, or from 0.10 kg, or from 0.12 kg, or from 0.15 kg, or from 0.18 kg, or from 0.20 kg, or from 0.22 kg, or from 0.25 kg fabric per litre of wash liquor is dosed into said wash liquor.

Preferably 50 g or less, more preferably 45 g or less, or 40 g or less, or 35 g or less, or 30 g or less, or 25 g or less, or 20 g or less, or even 15 g or less, or even 10 g or less of laundry detergent composition is contacted to water to form the wash liquor.

Preferably, the laundry detergent composition is contacted to 12 litres or less of water to form the wash liquor, or preferably to 40 litres or less of water, or preferably to 35 litres or less, or preferably to 30 litres or less, or preferably to 25 litres or less, or preferably to 20 litres or less, or preferably to 15 litres or less, or preferably to 12 litres or less, or preferably to 10 litres or less, or preferably to 8 litres or less, or even to 6 litres or less of water to form the wash liquor.

### Laundry Detergent Composition

The solid laundry detergent composition comprises bleach, and optionally other detergent ingredients. Suitable bleach ingredients are described in more detail below. Typically, the composition has a reserve alkalinity of at least 5.0, preferably at least 5.5, or at least 6.0, or at least 6.5, or at least 7.0, or at least 7.5, or at least 8.0, or at least 8.5, or at least 9.0, or at least 9.5, or at least 10.0, or at least 10.5, or at least 11.0, or at least 11.5, or at least 12.0, or at least 13, or at least 14, or at least 15, or at least 16, or at least 17, or at least 18, or at least 19, or at least 20. Preferably, the reserve alkalinity of the composition will not exceed 100. The reserve alkalinity is described in more detail below.

The composition can be any solid form, for example a solid powder or tablet form, or any combination thereof. The composition may in any unit dose form, for example a tablet or a pouch, or even a detergent sheet. However, it is extremely highly preferred for the composition to be in solid form, and it is especially preferred for the composition to be in a solid free-flowing particulate form, for example such that the composition is in the form of separate discrete particles.

The composition is a fully finished laundry detergent composition. Typically, if the composition is in free-flowing particulate form, the composition comprises a plurality of chemically different particles populations. The composition is not just a component of a laundry detergent composition that can be incorporated into a laundry detergent composition (such as an enzyme prill, or a surfactant particle, or a bleach particle), it is a fully finished laundry detergent composition. That said, it is within the scope of the present invention for an additional rinse additive composition (e.g. fabric conditioner or enhancer), or a main wash additive composition (e.g. bleach additive) to also be used in combination with the laundry detergent composition during the method of the present invention. Although, it may be preferred for no bleach additive composition is used in combination with the laundry detergent composition during the method of the present invention.

### Reserve Alkalinity

As used herein, the term “reserve alkalinity” is a measure of the buffering capacity of the laundry detergent composition (g/NaOH/100 g detergent composition) determined by titrating a 1% (w/v) solution of detergent composition with hydrochloric acid to pH 7.5 i.e in order to calculate Reserve Alkalinity as defined herein:

$$Reserve Alkalinity ( to pH 7.5 ) as \% alkali in g NaOH / 100 g product = \frac{T \times M \times 40 \times Vol}{10 \times Wt \times Aliquot}$$

T=titre (ml) to pH 7.5

M=Molarity of HCl=0.2

40=Molecular weight of NaOH

Vol=Total volume (ie. 1000 ml)

W=Weight of product (10 g)

Aliquot=(100 ml)

Obtain a 10 g sample accurately weighed to two decimal places, of fully formulated detergent composition. The sample should be obtained using a Pascall sampler in a dust cabinet. Add the 10 g sample to a plastic beaker and add 200 ml of carbon dioxide-free de-ionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls±1 ml aliquot using a 100 mls pipette immediately. Measure and record the pH and temperature of the sample using a pH meter capable of reading to ±0.01 pH units, with stirring, ensuring temperature is 21° C.+/−2° C. Titrate whilst stirring with 0.2M hydrochloric acid until pH measures exactly 7.5. Note the millilitres of hydrochloric acid used. Take the average titre of three identical repeats. Carry out the calculation described above to calculate reserve alkalinity to pH 7.5.

Preferably, the reserve alkalinity of the detergent compositions of the invention will be greater than 7.5 and preferably greater than 8. The reserve alkalinity may be greater than 9 or even greater than 9.5 or 10 or higher. The reserve alkalinity may be up to 20 or higher.

Adequate reserve alkalinity may be provided, at least in part, for example, by one or more of alkali metal silicates (excluding crystalline layered silicate), typically amorphous silicate salts, generally 1.0 to 2.2 ratio sodium salts, alkali metal, typically sodium, carbonate, bicarbonate and/or sesquicarbonates, persalts such as perborates and percarbonates also contribute to alkalinity. Sodium percarbonate may also be used.

Highly preferably the composition comprises highly weight efficient alkalinity sources. Preferred alkalinity sources are selected from sodium metasilicate, sodium hydroxide, and mixtures thereof.

### Source of Hydrogen Peroxide

The composition preferably comprises a source of hydrogen peroxide, preferably from above 0 wt % to 15 wt %, preferably from 1 wt %, or from 2 wt %, or from 3 wt %, or from 4 wt %, or from 5 wt %, and preferably to 12 wt % source of hydrogen peroxide. Preferably, the wash liquor comprises from above 0 g/l to 0.5 g/l hydrogen peroxide, preferably from 0.01 g/l, and preferably to 0.4 g/l, or even to 0.3 g/l, or to 0.2 g/l, or even to 0/1 g/l. Preferably, the laundry detergent composition comprises a source of hydrogen peroxide in an amount such that during the method of the present invention from above 0 g to 1.5 g, or to 1.0 g, or to 0.8 g, or to 0.6 g, or to 0.4 g source of hydrogen peroxide per litre of water is contacted to said water when forming the wash liquor.

Preferred sources of hydrogen peroxide include sodium perborate in, preferably in mono-hydrate or tetra-hydrate form or mixtures thereof, sodium percarbonate. Especially preferred is sodium percarbonate. The sodium percarbonate can be in the form of a coated percarbonate particle, the particle being a physically separate and discrete particle from the other particles of the laundry detergent composition, and especially from any bleach activator or the bleach ingredient. Alternatively, the percarbonate can be in the form of a co-particle that additionally comprises a bleach activator such as tetra-ethylene diamine (TAED) and the bleach ingredient. Highly preferred, when a co-particle form is used, a bleach activator at least partially, preferably completely, encloses the source of hydrogen peroxide.

### Detersive Surfactant

The composition preferably comprises detersive surfactant, preferably from 10 wt % to 40 wt %, preferably from 12 wt %, or from 15 wt %, or even from 18 wt % detersive surfactant. Preferably, the surfactant comprises alkyl benzene sulphonate and one or more detersive co-surfactants. The surfactant preferably comprises C₁₀-C₁₃ alkyl benzene sulphonate and one or more co-surfactants. The co-surfactants preferably are selected from the group consisting of C₁₂-C₁₈ alkyl ethoxylated alcohols, preferably having an average degree of ethoxylation of from 1 to 7; C₁₂-C₁₈ alkyl ethoxylated sulphates, preferably having an average degree of ethoxylation of from 1 to 5; and mixtures thereof. However, other surfactant systems may be suitable for use in the present invention.

Suitable detersive surfactants include anionic detersive surfactants, nonionic detersive surfactants, cationic detersive surfactants, zwitterionic detersive surfactants, amphoteric detersive surfactants and mixtures thereof.

Suitable anionic detersive surfactants include: alkyl sulphates; alkyl sulphonates; alkyl phosphates; alkyl phosphonates; alkyl carboxylates; and mixtures thereof. The anionic surfactant can be selected from the group consisting of: C₁₀-C₁₈ alkyl benzene sulphonates (LAS) preferably C₁₀-C₁₃ alkyl benzene sulphonates; C₁₀-C₂₀ primary, branched chain, linear-chain and random-chain alkyl sulphates (AS), typically having the following formula:

CH₃(CH₂)xCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

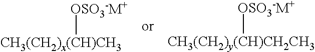

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. No. 6,020,303 and U.S. Pat. No. 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof.

Preferred anionic detersive surfactants include: linear or branched, substituted or unsubstituted alkyl benzene sulphonate detersive surfactants, preferably linear C₈-C₁₈ alkyl benzene sulphonate detersive surfactants; linear or branched, substituted or unsubstituted alkyl benzene sulphate detersive surfactants; linear or branched, substituted or unsubstituted alkyl sulphate detersive surfactants, including linear C₈-C₁₈ alkyl sulphate detersive surfactants, C₁-C₃ alkyl branched C₈-C₁₈ alkyl sulphate detersive surfactants, linear or branched alkoxylated C₈-C₁₈ alkyl sulphate detersive surfactants and mixtures thereof; linear or branched, substituted or unsubstituted alkyl sulphonate detersive surfactants; and mixtures thereof.

Preferred alkoxylated alkyl sulphate detersive surfactants are linear or branched, substituted or unsubstituted C₈₋₁₈ alkyl alkoxylated sulphate detersive surfactants having an average degree of alkoxylation of from 1 to 30, preferably from 1 to 10. Preferably, the alkoxylated alkyl sulphate detersive surfactant is a linear or branched, substituted or unsubstituted C₈₋₁₈ alkyl ethoxylated sulphate having an average degree of ethoxylation of from 1 to 10. Most preferably, the alkoxylated alkyl sulphate detersive surfactant is a linear unsubstituted C₈₋₁₈ alkyl ethoxylated sulphate having an average degree of ethoxylation of from 3 to 7.

Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₃ alkylbenzene sulphonates, preferably linear C₁₀₋₁₃ alkylbenzene sulphonates; and mixtures thereof. Highly preferred are linear C₁₀₋₁₃ alkylbenzene sulphonates. Highly preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable.

Suitable cationic detersive surfactants include: alkyl pyridinium compounds; alkyl quaternary ammonium compounds; alkyl quaternary phosphonium compounds; alkyl ternary sulphonium compounds; and mixtures thereof. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium as described in more detail in U.S. Pat. No. 6,004,922; polyamine cationic surfactants as described in more detail in WO 98/35002, WO 98/35003, WO 98/35004, WO 98/35005, and WO 98/35006; cationic ester surfactants as described in more detail in U.S. Pat. No. 4,228,042, U.S. Pat. No. 4,239,660, U.S. Pat. No. 4,260,529 and U.S. Pat. No. 6,022,844; amino surfactants as described in more detail in U.S. Pat. No. 6,221,825 and WO 00/47708, specifically amido propyldimethyl amine; and mixtures thereof. Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include halides (such as chloride), sulphate and sulphonate. Preferred cationic detersive surfactants are mono-C₆₋₁₈ alkyl mono-hydroxyethyl di-methyl quaternary ammonium chlorides. Highly preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable non-ionic detersive surfactant can be selected from the group consisting of: C₈-C₁₈ alkyl ethoxylates, such as, NEODOL® non-ionic surfactants from Shell; C₆-C₁₂ alkyl phenol alkoxylates wherein the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEx, wherein x=from 1 to 30, as described in more detail in U.S. Pat. No. 6,153,577, U.S. Pat. No. 6,020,303 and U.S. Pat. No. 6,093,856; alkylpolysaccharides as described in more detail in U.S. Pat. No. 4,565,647, specifically alkylpolyglycosides as described in more detail in U.S. Pat. No. 4,483,780 and U.S. Pat. No. 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic detersive surfactant could be an alkyl polyglucoside and/or an alkyl alkoxylated alcohol. Preferably the non-ionic detersive surfactant is a linear or branched, substituted or unsubstituted C₈₋₁₈ alkyl ethoxylated alcohol having an average degree of ethoxylation of from 1 to 10, more preferably from 3 to 7.

### Polymeric Carboxylate

The composition preferably comprises polymeric carboxylate. It may be preferred for the composition to comprise at least 5 wt % or at least 6 wt %, or at least 7 wt %, or at least 8 wt %, or even at least 9 wt %, by weight of the composition, of polymeric carboxylate. The polymeric carboxylate can sequester free calcium ions in the wash liquor. The carboxylate polymers can also act as soil dispersants and can provide an improved particulate stain removal cleaning benefit. Preferred polymeric carboxylates include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da.

### Zeolite Builder

Preferably, the composition comprise from 0 wt % to 10 wt % zeolite builder, preferably to 8 wt %, or to 6 wt %, or to 4 wt %, or even to 2 wt % zeolite builder. The composition may even be substantially free of zeolite builder, substantially free means “no deliberately added”. Typical zeolite builders are zeolite A, zeolite P and zeolite MAP.

### Phosphate Builder

Preferably, the composition comprise from Owt % to 10 wt % phosphate builder, preferably to 8 wt %, or to 6 wt %, or to 4 wt %, or even to 2 wt % phosphate builder. The composition may even be substantially free of phosphate builder, substantially free means “no deliberately added”. A typical phosphate builder is sodium tri-polyphosphate.

### Source of Carbonate

The composition may comprise a source of carbonate. Preferred sources of carbonate include sodium carbonate and/or sodium bicarbonate. A highly preferred source of carbonate is sodium carbonate. Sodium percarbonate may also be used as the source of carbonate.

### Bleach Activator

Preferably, the composition comprises a bleach activator. Suitable bleach activators are compounds which when used in conjunction with a hydrogen peroxide source leads to the in situ production of the peracid corresponding to the bleach activator. Various non limiting examples of bleach activators are disclosed in U.S. Pat. No. 4,915,854, issued Apr. 10, 1990 to Mao et al, and U.S. Pat. No. 4,412,934. The nonanoyloxybenzene sulfonate (NOBS) and tetraacetylethylenediamine (TAED) activators are typical, and mixtures thereof can also be used. See also U.S. Pat. No. 4,634,551 for other typical bleaches and activators useful herein. Another suitable bleach activator is decanoyloxybenzenecarboxylic acid (DOBA).

Highly preferred amido-derived bleach activators are those of the formulae:

R¹N(R⁵)C(O)R²C(O)L or R¹C(O)N(R⁵)R²C(O)L

wherein as used for these compounds R¹ is an alkyl group containing from about 6 to about 12 carbon atoms, R² is an alkylene containing from 1 to about 6 carbon atoms, R⁵ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the hydroperoxide anion. A preferred leaving group is oxybenzenesulfonate.

Preferred examples of bleach activators of the above formulae include (6-octanamido-caproyl)oxybenzenesulfonate, (6-nonanamidocaproyl)oxybenzenesulfonate, (6-decanamido-caproyl)oxybenzenesulfonate, and mixtures thereof as described in U.S. Pat. No. 4,634,551, incorporated herein by reference.

Another class of bleach activators comprises the benzoxazin-type activators disclosed by Hodge et al in U.S. Pat. No. 4,966,723, issued Oct. 30, 1990, incorporated herein by reference. A highly preferred activator of the benzoxazin-type is:

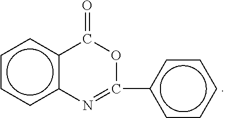

Still another class of preferred bleach activators includes the acyl lactam activators, especially acyl caprolactams and acyl valerolactams of the formulae:

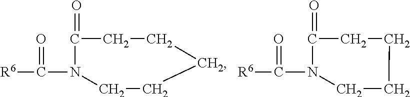

wherein as used for these compounds R⁶ is H or an alkyl, aryl, alkoxyaryl, or alkaryl group containing from 1 to about 12 carbon atoms. Highly preferred lactam activators include benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof. See also U.S. Pat. No. 4,545,784, issued to Sanderson, Oct. 8, 1985, incorporated herein by reference, which discloses acyl caprolactams, including benzoyl caprolactam, adsorbed into sodium perborate.

Preferred bleach activators are nonanoyloxybenzene sulfonate (NOBS) and/or tetraacetylethylenediamine (TAED).

It is highly preferred for a large amount of bleach activator relative to the source of hydrogen peroxide to be present in the laundry detergent composition. Preferably, the weight ratio of bleach activator to source of hydrogen peroxide present in the laundry detergent composition is at least 0.5:1, at least 0.6:1, at least 0.7:1, 0.8:1, preferably at least 0.9:1, or 1.0:1.0, or even 1.2:1 or higher.

### Chelant

The composition may comprise a chelant. Suitable chelants include diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). Preferably, the ethylene diamine-N′N′-disuccinic acid is in S′S′ enantiomeric form.

### Other Detergent Ingredients

The composition typically comprises other detergent ingredients. Suitable detergent ingredients include: imine bleach catalysts; transition metal catalysts; enzymes such as amylases, carbohydrases, cellulases, laccases, lipases, bleaching enzymes such as oxidases and peroxidases, proteases, pectate lyases and mannanases; suds suppressing systems such as silicone based suds suppressors; brighteners; hueing agents; photobleach; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as oligomers produced by the condensation of imidazole and epichlorhydrin; soil dispersants and soil anti-redeposition aids such as alkoxylated polyamines and ethoxylated ethyleneimine polymers; anti-redeposition components such as polyesters; perfumes such as perfume microcapsules; soap rings; aesthetic particles; dyes; fillers such as sodium sulphate, although it is preferred for the composition to be substantially free of fillers; silicate salt such as sodium silicate, including 1.6R and 2.0R sodium silicate; co-polyesters of di-carboxylic acids and diols; cellulosic polymers such as methyl cellulose, carboxymethyl cellulose, hydroxyethoxycelluloase, or other alkyl or alkylalkoxy cellulose; and any combination thereof.

### EXAMPLES

30 g of the following free-flowing particulate laundry detergent compositions were used to wash 3.0 kg fabric in a Miele 3622 front-loading automatic washing machine (13 L wash liquor volume, short wash cycle (1 h, 25 mins), 30° C. wash temperature).

| Ingredient | Composition A | | Composition B | | Composition C | | Composition D | |
|---|---|---|---|---|---|---|---|---|
| Sodium hydroxide | 3.0 | wt % | 4.0 | wt % | 0 | wt % | 2 | wt % |
| Sodium metasilicate | 0 | wt % | 0 | wt % | 10 | wt % | 8 | wt % |
| Tetraacetylethylenediamine | 10.0 | wt % | 7.5 | wt % | 12 | wt % | 10 | wt % |
| (TAED) | | | | | | | | |
| Sodium percarbonate (PC3) | 10.0 | wt % | 15 | wt % | 12 | wt % | 10 | wt % |
| hydroxyethane di[methylene | 0.5 | wt % | 0.5 | wt % | 0.1 | wt % | 0.8 | wt % |
| phosphonic acid] (HEDP) | | | | | | | | |
| C₁₁₋₁₃ alkyl benzene sulphonate | 18.0 | wt % | 23 | wt % | 15 | wt % | 18 | wt % |
| (LAS) | | | | | | | | |
| Ethoxylated C₁₂₋₁₅ alkyl sulphate | 5.0 | wt % | 5 | wt % | 10 | wt % | 7 | wt % |
| having average degree of | | | | | | | | |
| ethoxylation of between 1 and 3 | | | | | | | | |
| (AE₁₋₃S) | | | | | | | | |
| mono-C₈₋₁₀ alkyl mono- | 1.0 | wt % | 0.5 | wt % | 2.0 | wt % | 1.5 | wt % |
| hydroxyethyl di-methyl quaternary | | | | | | | | |
| ammonium chloride | | | | | | | | |
| Sodium sulphate | 3.0 | wt % | 0 | wt % | 0 | wt % | 1 | wt % |
| Sodium carbonate | 25.0 | wt % | 20 | wt % | 20 | wt % | 14 | wt % |
| Sodium silicate (1.6R) | 2.0 | wt % | 0 | wt % | 0 | wt % | 1.0 | wt % |
| Zeolite 4A | 2.0 | wt % | 0 | wt % | 0 | wt % | 1.0 | wt % |
| Florescent whitening agent | 0.5 | wt % | 0.5 | wt % | 0.1 | wt % | 0.5 | wt % |
| Silicone suds suppressor | 0.05 | wt % | 0.05 | wt % | 0.1 | wt % | 0.05 | wt % |
| Enzymes (protease, amylase, | 2.0 | wt % | 1.0 | w % | 1.5 | wt % | 2.0 | wt % |
| cellulase and mixtures thereof) | | | | | | | | |
| Co-polymer of maleic acid and | 8.0 | wt % | 10 | wt % | 12 | wt % | 10 | wt % |
| acrylic acid (MA/AA) | | | | | | | | |
| Polyethylene oxide with pendant | 2.0 | wt % | 2.0 | wt % | 1.0 | wt % | 1.5 | wt % |
| polyvinylacetate groups | | | | | | | | |
| Carboxymethyl cellulose (CMC) | 1.0 | wt % | 2.0 | wt % | 1.0 | wt % | 1.2 | wt % |
| Repel-o-tex | 0.1 | wt % | 0 | wt % | 0.2 | wt % | 0.15 | wt % |
| Moisture & Miscellaneous | to 100 | wt % | to 100 | wt % | to 100 | wt % | to 100 | wt % |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering fabric comprising the step of contacting a solid laundry detergent composition comprising bleach to water to form a wash liquor, and laundering fabric in said wash liquor,
wherein the composition has a reserve alkalinity of 5 or greater,
wherein the laundry detergent is contacted to water in such an amount so that the concentration of laundry detergent composition in the wash liquor is from above 0 g/1 to 5 g/l,
and wherein from 0.01 kg to 2 kg of fabric per litre of wash liquor is dosed into said wash liquor.

2. A method according to claim 1, wherein the composition has a reserve alkalinity of 7.5 or greater.

3. A method according to claim 1, wherein the composition has a reserve alkalinity of 10.0 or greater.

4. A method according to claim 1, wherein the composition comprises sodium metasilicate.

5. A method according to claim 1, wherein the composition comprises sodium hydroxide.

6. A method according to claim 1, wherein the composition is in free-flowing particulate form.

7. A method according to claim 1, wherein the composition comprises from above about 0 wt % to about 15 wt % source of hydrogen peroxide, and wherein from about 0.1 g to about 0.5 g source of peroxide per litre of water is contacted to said water when forming said wash liquor.

8. A method according to claim 1, wherein the composition comprises:
(a) detersive surfactant;
(b) carboxylate polymer;
(c) less than about 10 wt % zeolite builder:
(d) less than about 10 wt % phosphate builder;
(e) optionally another detergent ingredient

9. A method according to claim 1, wherein about 40 g or less of laundry detergent composition is contacted to water to form the wash liquor.

10. A method according to claim 1, wherein the laundry detergent composition is contacted to about 15 litres or less of water to form the wash liquor.

11. A method according to claim 1, wherein the laundry detergent is contacted to water in such an amount so that the concentration of laundry detergent composition in the wash liquor is from about 1 g/l to about 4 g/1.

12. A method according to claim 1, wherein at least about 0.2 kg fabric per litre of wash liquor is dosed into said wash liquor.

13. A method according to claim 1, wherein the method is carried out using a front-loading automatic washing machine.

14. A laundry detergent composition suitable for use in the method according to claim 1, wherein the composition comprises:
(a) detersive surfactant;
(b) optionally sodium hydroxide and/or sodium metasilicate;
(c) bleach activator;
(d) source of hydrogen peroxide;
(e) from about 0 wt % to about 10 wt % zeolite builder;
(f) from about 0 wt % to about 10 wt % phosphate builder;
